(19) United States
(12) Patent Application Publication
(10) Pub. No.: US 2024/0088559 A1
(43) Pub. Date: Mar. 14, 2024

(54) MILLIMETER WAVE MODULE CIRCUIT AND TERMINAL DEVICE

(71) Applicant: Honor Device Co., Ltd., Shenzhen (CN)

(72) Inventors: Cheng JIANG, Shenzhen (CN); Yu WANG, Shenzhen (CN); Zengchao QU, Shenzhen (CN); Tianyu PEN, Shenzhen (CN); Dongping LIU, Shenzhen (CN)

(73) Assignee: Honor Device Co., Ltd., Shenzhen (CN)

(21) Appl. No.: 18/274,464

(22) PCT Filed: Dec. 22, 2022
(86) PCT No.: PCT/CN2022/141111

§ 371 Date: Jul. 27, 2023

(30) Foreign Application Priority Data
Jan. 12, 2022 (CN) 202210031486.X

(51) Int. Cl. H01Q 3/36; H01Q 1/24; H01Q 3/28; H04M 1/02

(52) U.S. Cl. CPC H01Q 3/36; H01Q 1/243; H01Q 3/28; H04M 1/0266

(57) ABSTRACT

Embodiments of this application relate to the field of terminal technologies, and provides a millimeter wave module circuit and a terminal device. The first antenna array includes N first antennas, and the second antenna array includes M second antennas, where N is greater than M. The processing module includes a plurality of first processing units. Each of N first antennas is connected to each first processing unit. Each of M second antennas is separately connected to two different first processing units. The first processing unit includes a power amplifier. The processing module is configured to send, through differential feeding, a second signal to the second antenna by using two different first processing units. This can enable a signal coverage of the second antenna array to be increased, improving performance of a millimeter wave module in a coverage region of the second antenna array.

### CROSS-REFERENCE TO RELATED APPLICATIONS

This application is a national stage of International Application No. PCT/CN2022/141111, filed on Dec. 22, 2022, which claims priority to Chinese Patent Application No. 202210031486.X, filed on Jan. 12, 2022. The disclosures of both of the aforementioned applications are hereby incorporated by reference in their entireties.

### TECHNICAL FIELD

Embodiments of this application relate to the field of terminal technologies, and in particular to a millimeter wave module circuit and a terminal device.

### BACKGROUND

A millimeter wave antenna module, referred to as a “millimeter wave module circuit”, is a component that includes a millimeter wave radio frequency (RF) front end and an antenna array. Because a millimeter wave attenuates greatly during radiation, a coverage of millimeter wave radiation is usually small. To expand the coverage of the millimeter wave radiation, a plurality of antenna arrays are usually disposed on a terminal device in different directions. Therefore, as shown in FIG. 1, coverages of the millimeter wave radiation may be superimposed on each other in different directions, and the coverages of the millimeter wave radiation are expanded. Usually, quantities of antennas in a plurality of antenna arrays disposed in different directions are the same.

However, because an increasing quantity of electronic components are integrated on the terminal device, an area of a region in which an antenna array is disposed on the terminal device is getting increasingly small. This enables a quantity of antennas included in the antenna array disposed in the region to be reduced and further causes a quantity of antennas included in some antenna arrays in the millimeter wave module circuit to be less than a quantity of antennas in other antenna arrays. A gain of an antenna array is usually related to a quantity of antennas included in the antenna array. As the quantity of antennas is reduced, the gain of an antenna array decreases. This causes performance of the millimeter wave module circuit to be deteriorated in a region covered by the antenna array.

Based on this, how to improve the performance of the millimeter wave module circuit has become a problem to be resolved urgently.

### SUMMARY

Embodiments of this application provide a millimeter wave module circuit and an electronic device, which can improve performance of the millimeter wave module circuit.

According to a first aspect, a millimeter wave module circuit is provided. The millimeter wave module circuit includes a first antenna array, a second antenna array, and a processing module. The first antenna array includes N first antennas, and the second antenna array includes M second antennas, where N is greater than M. The processing module includes a plurality of first processing units. Each of N first antennas is connected to each first processing unit in a one-to-one correspondence. Each of M second antennas is in a differential connection to two different first processing units. The first processing unit includes a power amplifier.

The processing module is configured to send a first signal to the first antenna by using the first processing unit.

The processing module is configured to send, through differential feeding, a second signal to the second antenna by using two different first processing units.

The first antenna array is configured to radiate a millimeter wave signal based on the first signal.

The second antenna array is configured to radiate a millimeter wave signal based on the second signal.

A millimeter wave module circuit provided in an embodiment of this application includes a first antenna array, a second antenna array, and a processing module. The first antenna array includes N first antennas, and the second antenna array includes M second antennas, where N is greater than M. The processing module includes a plurality of first processing units. Each of N first antennas is connected to each first processing unit. Each of M second antennas is separately connected to two different first processing units. The first processing unit includes a power amplifier. The processing module is configured to send a first signal to the first antenna by using the first processing unit. The processing module is configured to send, through differential feeding, a second signal to the second antenna by using two different first processing units. The first antenna array is configured to radiate a millimeter wave signal based on the first signal. The second antenna array is configured to radiate a millimeter wave signal based on the second signal. Because the quantity M of antennas in the second antenna array is less than the quantity N of antennas in the first antenna array, a gain of the second antenna array is less than a gain of the first antenna array. By reasonably adjusting phases of signals input by two different first processing units into the second antenna, a strength of the second signal input into the second antenna is greater than a strength of the first signal input into the first antenna. In other words, in the millimeter wave module circuit provided in this embodiment of this application, the gain of the second antenna array is compensated by increasing the strength of the second signal. This enables a strength of the millimeter wave signal radiated by the second antenna array to be increased. As the strength of millimeter wave signal radiated by the second antenna array is increased, a signal coverage of the second antenna array is increased, improving performance of a millimeter wave module in a coverage region of the second antenna array.

In an embodiment, the first processing unit further includes a phase shifter. The phase shifter is configured to adjust a phase of an input signal received by the first processing unit. The processing module is configured to obtain a third signal by using the phase shifter in a first target processing unit. The processing module is configured to obtain a fourth signal by using the phase shifter in a second target processing unit. A phase difference between the third signal and the fourth signal is 180°. The second signal is a differential signal obtained by combining the third signal and the fourth signal. The first target processing unit is one of the two different first processing units, and the second target processing unit is the other of the two different first processing units.

In an embodiment of this application, the first processing unit further includes a phase shifter. The phase shifter is configured to adjust a phase of an input signal received by the first processing unit. The processing module is configured to obtain a third signal by using the phase shifter in a first target processing unit. The processing module is configured to obtain a fourth signal by using the phase shifter in a second target processing unit. A phase difference between the third signal and the fourth signal is 180°. The second signal is a differential signal obtained by combining the third signal and the fourth signal. The first target processing unit is one of the two different first processing units, and the second target processing unit is the other of the two different first processing units. That is, the processing module adjusts, by using the phase shifter, phases of signals output by two first processing units connected to the second antennas. This enables a phase difference to exist between the third signal and the fourth signal input into the second antenna. Further, the phase difference between the third signal and the fourth signal is used to increase an amplitude of the second signal input into the second antenna, to compensate a gain of the second antenna array, increasing a strength of a millimeter wave signal radiated by the second antenna array. As the strength of millimeter wave signal radiated by the second antenna array is increased, a signal coverage of the second antenna array is increased, improving performance of a millimeter wave module in a coverage region of the second antenna array. Further, the phase difference between the third signal and the fourth signal is 180°. Through differential feeding, an amplitude of the second signal is a sum of an amplitude of the third signal and an amplitude of the fourth signal. In other words, the amplitude of the second signal is maximized, enabling the strength of the millimeter wave signal radiated by the second antenna array to be maximized, further improving the performance of the terminal device.

In an embodiment, a first processing unit connected to the first antenna is one of the two different first processing units.

A millimeter wave module circuit in an embodiment of this application includes a first antenna array, a second antenna array, and a processing module. The first antenna array includes N first antennas, and the second antenna array includes M second antennas, where N is greater than M. The processing module includes a plurality of first processing units. Each of N first antennas is connected to each first processing unit. Each of M second antennas is separately connected to two different first processing units. A first processing unit connected to the first antenna is any one of two first processing units connected to the second antenna, and the first processing unit includes the power amplifier. The processing module is configured to send, by using one first processing unit, a first signal to the first antenna in a first time period. The processing module is configured to send, by using two first processing units, a second signal to the second antenna in a second time period. An amplitude of the second signal is greater than an amplitude of the first signal. The first antenna array is configured to radiate a millimeter wave signal based on the first signal. The second antenna array is configured to radiate a millimeter wave signal based on the second signal. Equivalently, the first antenna and the second antenna in this embodiment of this application multiplex one first processing unit, reducing a quantity of the first processing units in the millimeter wave module circuit and saving space on the terminal device.

In an embodiment, the processing module is configured to send a first signal to the first antenna in a first time period and send a second signal to the second antenna in a second time period.

It should be understood that the first time period may be a time period in which a switch is in a first switch-on state, and the second period may be a time period in which the switch is in a second switch-on state.

In an embodiment, the first processing unit further includes a switch and a low noise amplifier. When the switch is in the first switch-on state, the processing module is configured to send a first signal to the first antenna and transmit a signal received by the second antenna to the low noise amplifier. When the switch is in the second switch-on state, the processing module is configured to send the second signal to the second antenna and transmit a signal received by the first antenna to the low noise amplifier.

In this embodiment of this application, when the switch is in the first switch-on state, the processing module is configured to send the first signal to the first antenna and transmit the signal received by the second antenna to the low noise amplifier. When the switch is in the second switch-on state, the processing module is configured to send the second signal to the second antenna and transmit a signal received by the first antenna to the low noise amplifier. Therefore, when the first antenna and the second antenna multiplex one first processing unit, the second antenna array can receive a signal through different switch-on states of the switch when the first antenna array radiates the millimeter wave signal. When the second antenna array radiates the millimeter wave signal, the first antenna array receives a signal, preventing, when the first antenna array radiates the millimeter wave signal, that the second antenna array is to receive a signal through a same signal channel, or preventing, when the second antenna array radiates the millimeter wave signal, that the second antenna array is to receive a signal through a same signal channel, further preventing a signal conflict caused by receiving of a signal and radiation of the millimeter wave signal through the same signal channel.

In an embodiment, the switch is a double-pole double throw switch, and the power amplifier is separately connected to a phase shifter and the double-pole double throw switch. When the switch is in the first switch-on state, the power amplifier is connected to the first antenna through the double-pole double throw switch, and the low noise amplifier is connected to the second antenna through the switch. When the switch is in the second switch-on state, the power amplifier is connected to the second antenna through the double-pole double throw switch, and the low noise amplifier is connected to the first antenna through the switch. In an embodiment, a quantity of the plurality of first processing units is greater than or equal to N and greater than or equal to 2*M.

In an embodiment, a quantity of the first antennas is twice a quantity of the second antennas. A quantity of the plurality of first processing units is N and is equal to 2*M.

In this embodiment of this application, a quantity of the first antennas is twice a quantity of the second antennas, and a second antenna is connected to two first processing units. The quantity of the plurality of first processing units is N, and is equal to 2*M. That is, the millimeter wave module circuit in this embodiment of this application may be implemented by a least quantity of the first processing units, further saving the space on the terminal device.

According to a second aspect, a millimeter wave module circuit is provided. The millimeter wave module circuit includes a first antenna array, a second antenna array, and a processing module. The first antenna array includes four first antennas, and the second antenna array includes two second antennas. The processing module includes four first processing units. Each of the four first antennas is connected to each first processing unit in a one-to-one correspondence. One of the two second antennas is differentially connected to two of the four first processing units, and the other of the two second antennas is differentially connected to the other two of the four first processing units. The first processing unit includes a power amplifier.

The processing module is configured to send a first signal to the first antenna by using the first processing unit.

The processing module is configured to send, through differential feeding, a second signal to the second antenna by using two different first processing units.

The first antenna array is configured to radiate a millimeter wave signal based on the first signal.

The second antenna array is configured to radiate a millimeter wave signal based on the second signal.

An implementation and beneficial effects of the foregoing millimeter wave module circuit are similar to an implementation and beneficial effects of the millimeter wave module circuit described in the first aspect. The details are not described herein again.

According to a third aspect, a terminal device is provided. The terminal device is a body. One side of the body is a display, and the other side is a backplate. The display and the backplate are connected through a middle frame. The display, the backplate, and the middle frame form an accommodating cavity. The millimeter wave module circuit described in the foregoing first aspect is disposed in the accommodating cavity.

In an embodiment, the millimeter wave module circuit in the terminal device includes a first antenna array and a second antenna array. The first antenna array is disposed in a plane in which the backplate is located, and the second antenna array is disposed in any plane in which the middle frame is located. Alternatively, the first antenna array and the second antenna array are respectively disposed in two different planes in which the middle frame is located.

An implementation and beneficial effects of the foregoing terminal device are similar to an implementation and beneficial effects of the millimeter wave module circuit described in the first aspect. The details are not described herein again.

### BRIEF DESCRIPTION OF DRAWINGS

FIG. 1 is a schematic diagram of a structure of an electronic device;

FIG. 2 is a schematic diagram of a radiation coverage of a millimeter wave module circuit;

FIG. 3 is a schematic diagram of a structure of an electronic device;

FIG. 4 is a schematic diagram of a radiation coverage of a millimeter wave module circuit;

FIG. 5 is a schematic diagram of a structure of a millimeter wave module circuit according to an embodiment of this application;

FIG. 6 is a schematic diagram of flow paths of a second signal, a third signal, and a fourth signal according to an embodiment of this application;

FIG. 7 is a schematic diagram of synthesizing a second signal by using a third signal and a fourth signal according to an embodiment of this application;

FIG. 8 is a schematic diagram of a structure of a millimeter wave module circuit according to another embodiment of this application;

FIG. 9 is a schematic diagram of a signal flow path when a switch is in a first switch-on state according to an embodiment of this application;

FIG. 10 is a schematic diagram of a signal flow path when a switch is in a second switch-on state according to an embodiment of this application;

FIG. 11 is a schematic diagram of a structure of an electronic device according to an embodiment of this application;

FIG. 12 is a schematic diagram of a positional relationship of three antenna arrays according to an embodiment of this application;

FIG. 13 is a schematic diagram of a positional relationship of three antenna arrays according to another embodiment of this application; and

FIG. 14 is a schematic diagram of a positional relationship of three antenna arrays according to another embodiment of this application.

### DESCRIPTION OF EMBODIMENTS

The following clearly describes technical solutions in embodiments of this application in detail with reference to accompanying drawings. In descriptions of embodiments of this application, unless otherwise specified, “I” indicates “or”. For example, A/B may indicate A or B. The term “and/or” in this specification describes only an association relationship for describing associated objects, and indicates that three relationships may exist. For example, A and/or B may indicate the following three cases: Only A exists, both A and B exist, and only B exists. In addition, in the descriptions of embodiments of this application, “a plurality of” means two or more.

In the following, the terms “first” and “second” are used merely for descriptive purposes, and cannot be understood as indicating or implying relative importance or implicitly indicating a quantity of indicated technical features. Therefore, a feature limited by “first” or “second” may explicitly or implicitly include one or more features. In the descriptions of embodiments of this application, unless otherwise specified, “a plurality of” means two or more than two.

Before technical solutions of embodiments of this application are described, technical scenarios and technical terms in this application are introduced first.

The technical solutions of this application relate to the field of antenna technologies, and in particular to a millimeter wave antenna circuit. The circuit may be used in an electronic device. Further, the electronic device may be a terminal device (referred to as a terminal). The terminal may be a device that provides a service and/or data connectivity to a user, a handheld device with a wireless connection function, or another processing device connected to a wireless modem, such as a wireless terminal, a vehicle-mounted wireless terminal, a portable device, a wearable device, a mobile phone (or referred to as a “cellular” phone), a portable terminal, a pocket-sized terminal, a handheld terminal, or the like, which exchanges a language and/or data with a wireless access network. For example, the terminal may be a device such as a personal communication service (PCS) phone, a cordless telephone set, a session initiation protocol (SIP) phone, a wireless local loop (WLL) station, a personal digital assistant (PDA), or the like. The wireless terminal may alternatively be a subscriber unit, a mobile station (mobile), a remote terminal, an access terminal, a user terminal, a user agent, a user device, or a user equipment (UE). A type of the terminal device is not limited in this application.

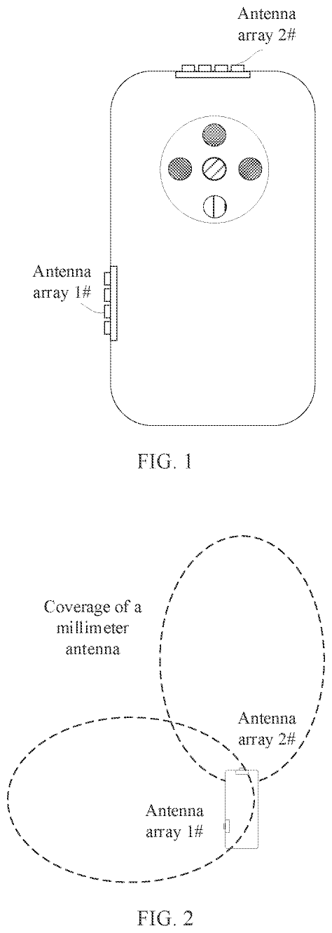

FIG. 1 provides a schematic diagram of a structure of a terminal device. A millimeter wave module circuit on the terminal device includes two antenna arrays, namely, an antenna array 1# and an antenna array 2#. The two antenna arrays are disposed on different planes of the terminal device respectively. Each antenna array has a beam coverage.

As shown in FIG. 2, a millimeter wave beam radiated by each antenna array is a unidirectional and forward beam. A working mechanism of the two antenna arrays: Only either of the antenna array 1# or the antenna array 2# may be selected simultaneously for communication. Therefore, an effect of antenna coverage of an entire terminal device is simple superposition of antenna arrays in a millimeter wave radiation direction, and an effect diagram of coverage of millimeter wave beams for the entire terminal device is shown in FIG. 2.

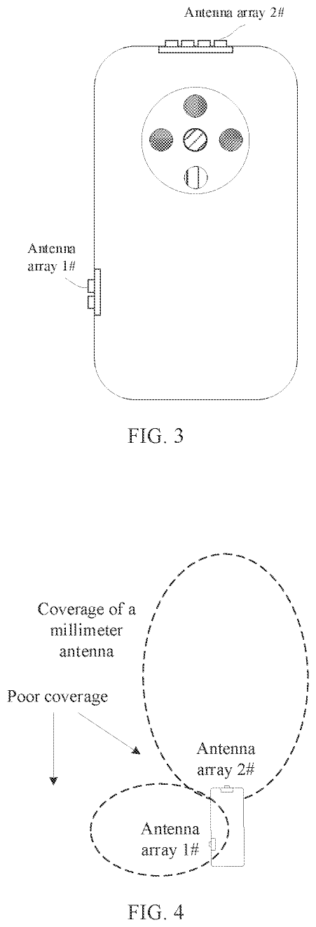

At present, as an increasing quantity of electronic components are integrated on the terminal device, an area of a region in which an antenna array is disposed on the terminal device is getting increasingly small. In a possible case, when an available area of a region in which an antenna array is disposed on the terminal device is small, a plurality of antennas cannot be disposed in the region, and further, a quantity of antennas in one antenna array is less than a quantity of antennas in another antenna array. It should be understood that as a quantity of antennas is increased, a gain of the antennas is high, and a beam of a corresponding antenna array is large. When a quantity of antennas in one antenna array is less than a quantity of antennas in another antenna array, it indicates that a beam of the antenna array is short. For example, as shown in FIG. 3, a quantity of antennas in an antenna array 1# is small. This leads to a short radiation beam corresponding to the antenna array 1#. As shown in FIG. 4, this enables a coverage of a terminal device in a direction of the antenna array 1# to be small.

In view of this, this application provides a millimeter wave module circuit. The millimeter wave module circuit can increase a coverage of an antenna array with a small quantity of antennas, improving performance of the terminal device.

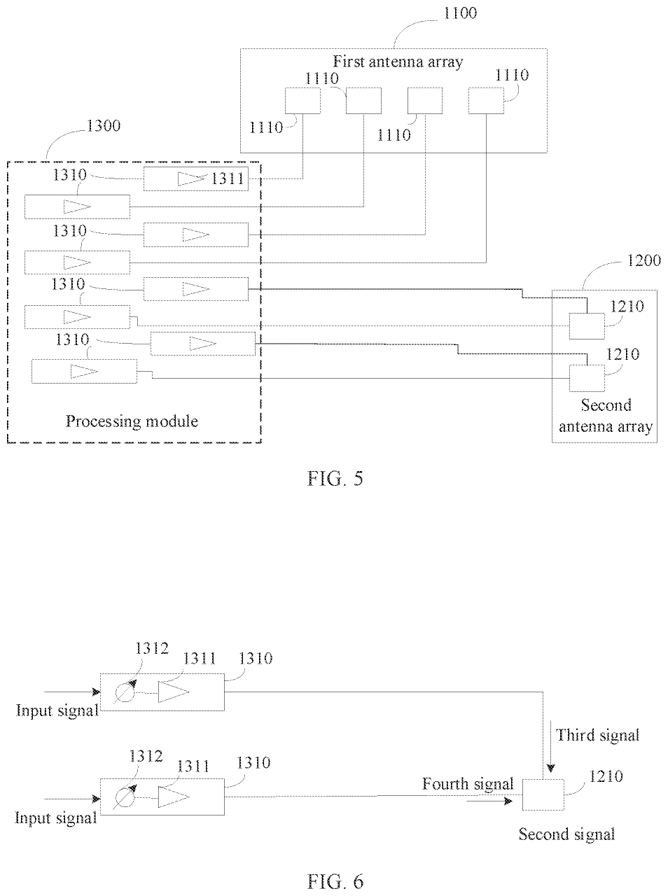

Details are described below with reference to embodiments shown in FIG. 5 to FIG. 10.

FIG. 5 is a schematic diagram of a structure of a millimeter wave module circuit according to an embodiment of this application. As shown in FIG. 5, the millimeter wave module circuit includes a first antenna array 1100, a second antenna array 1200, and a processing module 1300. The first antenna array 1100 includes N first antennas 1110, and the second antenna array 1200 includes M second antennas 1210, where N is greater than M. The processing module 1300 includes a plurality of first processing units 1310, and each of N first antennas 1110 is connected to each first processing unit 1310 in a one-to-one correspondence. Each of M second antennas 1210 is in a differential connection to two different first processing units 1310. The first processing unit 1310 includes a power amplifier 1311. The processing module 1300 is configured to send a first signal to the first antenna 1310 by using one first processing unit 1310. The processing module 1300 is configured to send, through differential feeding, a second signal to the second antenna 1210 by using the two different first processing units 1310. An amplitude of the second signal is greater than an amplitude of the first signal. The first antenna array 1100 is configured to radiate a millimeter wave signal based on the first signal. The second antenna array 1200 is configured to radiate a millimeter wave signal based on the second signal.

It should be understood that the first antenna array 1100 and the second antenna array 1200 are usually perpendicular to each other. In other words, an included angle between the first antenna array 1100 and the second antenna array 1200 is 90°, or an included angle between the first antenna array 1100 and the second antenna array 1200 is within an angle range. For example, if the included angle between the first antenna array 1100 and the second antenna array 1200 is within a range of 75° to 115°, it is considered that the first antenna array 1100 and the second antenna array 1200 are perpendicular to each other, which is not limited in this embodiment of this application.

The millimeter wave module circuit provided in this embodiment of this application may further include a third antenna array and more antenna arrays, which is not limited in this embodiment of this application.

The first antenna array 1100 includes N first antennas 1110, and the second antenna array 1200 includes M second antennas 1210, where N is greater than M. In other words, a quantity of antennas in the first antenna array 1110 is greater than a quantity of antennas in the second antenna array 1200. It should be understood that as a quantity of antennas is increased, a gain of a corresponding antenna array is high. Because a quantity of antennas in the first antenna array 1110 is greater than a quantity of antennas in the second antenna array 1200, a gain of the first antenna array 1100 is greater than a gain of the second antenna array 1200.

An antenna in an antenna array is a patch antenna. That is, the first antenna 1110 and the second antenna 1210 are both patch antennas. The patch antenna is a pie-shaped directional antenna, and includes two metal plates (one is larger than the other) that are superimposed, with a sheet dielectric in the middle, which is appropriate for covering a single-story small office, a small shop, and another access point. The patch antenna generates a hemispherical covering surface. A propagation range from an installation point may be between 30° and 180°. In addition, each patch antenna supports two feeding modes: horizontal polarization and vertical polarization.

Each first antenna 1110 in the first antenna array 1100 is connected to one first processing unit 1310. Then a first signal input into the first antenna 1110 is obtained by amplifying an input signal by using a power amplifier 1311 in one first processing unit.

Each second antenna 1210 in the second antenna array 1200 is connected to two different first processing units 1310. Then a second signal input into the second antenna 1210 is obtained by amplifying input signals by power amplifiers 1311 in two first processing units 1310. By adjusting phases of two signals input into the second antenna 1210, an amplitude of the second signal may be increased. That is, the amplitude of the second signal is greater than an amplitude of the first signal.

One first processing unit is connected to each first antenna 1110, and two different first processing units 1310 are connected to each second antenna 1210. For example, when there are two second antennas 1210, two first processing units 1310 connected to one second antenna 1210 and two first processing units 1310 connected to another second antenna 1210 are not the same first processing unit 1310.

The first processing unit connected to the first antenna 1100 may be any one of two different first processing units connected to the second antenna 1210, or may not be any one of the two different first processing units connected to the second antenna 1210, which is not limited in this embodiment of this application.

Because the amplitude of the second signal input into the second antenna 1210 is greater than the amplitude of the first signal input into the first antenna 1110, a strength of a millimeter wave signal radiated by the second antenna array 1200 can be increased by increasing a strength of a signal input into the second antenna 1210 in the second antenna array 1200 when a gain of the second antenna array 1200 is less than a gain of the first antenna array 1100.

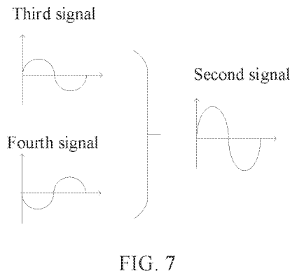

How to obtain the second signal is described in detail with reference to FIG. 6 and FIG. 7.

In the millimeter wave module circuit, working time periods of antennas in one antenna array are different. Therefore, the first processing unit 1310 usually includes a phase shifter 1312. The phase shifter 1312 is configured to adjust phases of signals input into antennas, so that the antennas can work in different time periods. In embodiments of this application, the phase shifters 1312 in the first processing units 1310 are used, to adjust phases of two signals input into the second antenna 1210, to increase a strength of the second signal.

Optionally, the first processing unit 1310 further includes a phase shifter 1312, and the phase shifter 1312 is configured to adjust a phase of an input signal received by the first processing unit 1310. The processing module 1300 is configured to obtain a third signal by using the phase shifter 1312 in a first target processing unit. The processing module 1300 is configured to obtain a fourth signal by using the phase shifter 1312 in a second target processing unit. A phase difference between the third signal and the fourth signal is a preset phase difference. The processing module 1300 is configured to obtain the second signal based on the third signal and the fourth signal. The first target processing unit means one of two first processing units connected to the second antenna 1210, and the second target processing unit means the other of the two first processing units connected to the second antenna 1210.

When the second antenna 1210 is connected to two first processing units 1310, one of the first processing units 1310 is the first target processing unit and the other of the first processing units 1310 is the second target processing unit.

For example, as shown in FIG. 6, one second antenna 1210 is connected to two first processing units 1310. An upper first processing unit 1310 is the first target processing unit, and a lower first processing unit 1310 is the second target processing unit.

The terminal device further includes a baseband module (not shown in the figure). The baseband module is configured to generate and send a baseband signal. It should be understood that the baseband module may be a baseband chip, for example, a modem. The baseband module sends the baseband signal to the first processing unit 1310 as an input signal of the first processing unit. For example, input signals input into the first target processing unit and the second target processing unit are shown in FIG. 6. A phase of an input signal is adjusted by the phase shifter 1312 in the first target processing unit, and an adjusted input signal arrives at an input end of the second antenna 1210 and is referred to as the third signal. It should be understood that a feeder connecting the first target processing unit and the second antenna 1210 is usually a microstrip line, and a length of the microstrip line usually changes a phase of a signal. In other words, the input signal passes through the first target processing unit and a feeder, to be changed into the third signal. A phase difference between the input signal and the third signal is determined by the phase shifter 1312 in the first target processing unit and a length of the feeder.

Similarly, a phase of an input signal is adjusted by the phase shifter 1312 in the second target processing unit, and an adjusted input signal arrives at an input end of the second antenna 1210 and is referred to as the fourth signal. A phase difference between the input signal and the fourth signal is determined by the phase shifter 1312 in the second target processing unit and a length of a feeder.

To determine a phase difference between the third signal and the fourth signal, generally, the length of the feeder between the first target processing unit and the second antenna 1210 is equal to the length of the feeder between the second target processing unit and the second antenna 1210. In this case, the phase difference between the third signal and the fourth signal may be determined by determining only a value of a phase of the input signal changed by the phase shifter 1312 in the first target processing unit and a value of a phase of the input signal changed by the phase shifter 1312 in the second target processing unit.

Optionally, the phase difference between the third signal and the fourth signal is a preset phase difference, and the preset phase difference is 180°.

For example, as shown in FIG. 7, when the phase difference between the third signal and the fourth signal is 180°, differential feeding is implemented on the second antenna. Because differential feeding is used for the third signal and the fourth signal and loaded on the second antenna simultaneously, an amplitude of a signal loaded on the second antenna is enhanced. A strength of the signal is similar to a strength of a second signal in FIG. 7.

In this embodiment of this application, the phase difference between the third signal and the fourth signal is 180°. Through differential feeding, the strength of the signal loaded on the second antenna is similar to the amplitude of the second signal, that is, a sum of an amplitude of the third signal and an amplitude of the fourth signal. In other words, the amplitude of the second signal is maximized, enabling the strength of the millimeter wave signal radiated by the second antenna array to be maximized, further improving the performance of the terminal device.

By using an enhanced second signal, the strength of the millimeter wave signal radiated by the second antenna array 1200 is also enhanced, increasing a coverage of the second antenna array 1200.

A millimeter wave module circuit provided in an embodiment of this application includes a first antenna array, a second antenna array, and a processing module. The first antenna array includes N first antennas, and the second antenna array includes M second antennas, where N is greater than M. The processing module includes a plurality of first processing units, and each of N first antennas is connected to each first processing unit. Each of M second antennas is separately connected to two different first processing units. The first processing unit includes a power amplifier. The processing module is configured to send a first signal to the first antenna by using the first processing unit. The processing module is configured to send, through differential feeding, a second signal to the second antenna by using two different first processing units. The first antenna array is configured to radiate a millimeter wave signal based on the first signal. The second antenna array is configured to radiate a millimeter wave signal based on the second signal. Because the quantity M of antennas in the second antenna array is less than the quantity N of antennas in the first antenna array, a gain of the second antenna array is less than a gain of the first antenna array. By reasonably adjusting phases of signals input by two different first processing units into the second antenna, a strength of the second signal input into the second antenna is greater than a strength of the first signal input into the first antenna. In other words, in the millimeter wave module circuit provided in this embodiment of this application, the gain of the second antenna array is compensated by increasing the strength of the second signal. This enables a strength of the millimeter wave signal radiated by the second antenna array to be increased. As the strength of millimeter wave signal radiated by the second antenna array is increased, a signal coverage of the second antenna array is increased, improving performance of a millimeter wave module in a coverage region of the second antenna array.

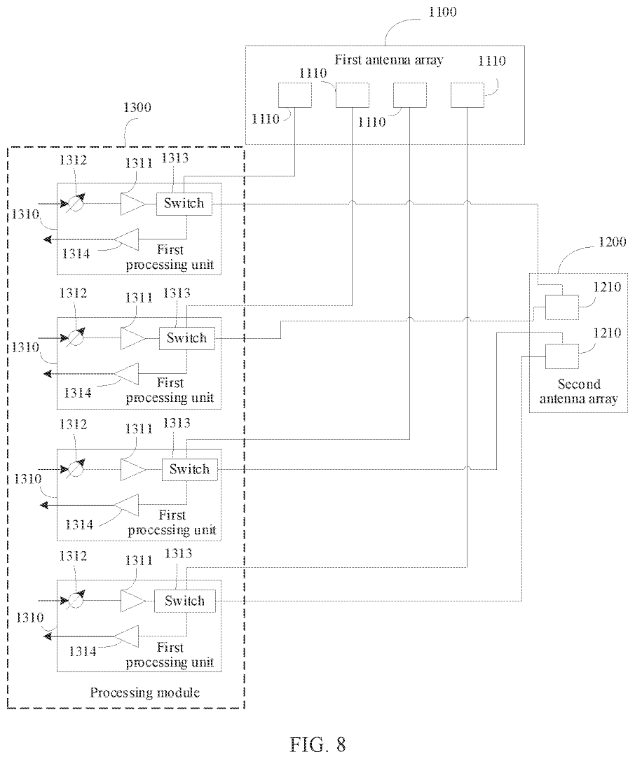

In a possible case, the first antenna and the second antenna may multiplex one first processing unit. In this way, a quantity of the first processing units may be reduced, and space occupied by the millimeter wave module circuit in the terminal device may be further reduced. Details are described below with reference to embodiments shown in FIG. 8 to FIG. 10.

FIG. 8 is a schematic diagram of a structure of a millimeter wave module circuit according to another embodiment of this application. As shown in FIG. 8, the millimeter wave module circuit includes a first antenna array 1100, a second antenna array 1200, and a processing module 1300. The first antenna array 1100 includes N first antennas 1110, and the second antenna array 1200 includes M second antennas 1210, where N is greater than M. The processing module 1300 includes a plurality of first processing units 1310. Each of N first antenna 1110 of N first antennas is connected to each first processing unit. Each of M second antennas is in a differential connection to two different first processing units. A first processing unit connected to the first antenna is any one of two different first processing units connected to the second antenna. The first processing unit 1310 includes a power amplifier 1311, a phase shifter 1312, a switch 1313, and a low noise amplifier 1314. When the switch 1313 is in a first switch-on state, the processing module 1300 is configured to send a first signal to the first antenna 1110 in a first time period and transmit a signal received by the second antenna 1210 to the low noise amplifier 1314. When the switch 1313 is in a second switch-on state, the processing module 1300 is configured to send a second signal to the second antenna 1210 in a second time period through differential feeding, and transmit a signal received by the first antenna 1110 to the low noise amplifier 1314. An amplitude of the second signal is greater than an amplitude of the first signal. The first antenna array 1100 is configured to radiate a millimeter wave signal based on the first signal. The second antenna array 1200 is configured to radiate a millimeter wave signal based on the second signal.

A first processing unit connected to the first antenna 1110 may be any one of the two different first processing units connected to the second antenna 1210, that is, one first processing unit 1310 is to be multiplexed by the first antenna 1110 and the second antenna 1210. In the millimeter wave module circuit, different antenna arrays have different working time periods. Therefore, the processing module 1300 sends the first signal to the first antenna 1110 in the first antenna array 1100 in the first time period and sends the second signal to the second antenna 1210 in the second antenna array 1200 in the second time period. This enables a same first processing unit 1310 to be multiplexed between the first antenna 1110 and the second antenna 1210.

A millimeter wave module circuit in an embodiment of this application includes a first antenna array, a second antenna array, and a processing module. The first antenna array includes N first antennas, and the second antenna array includes M second antennas, where N is greater than M. The processing module includes a plurality of first processing units. Each of N first antennas is connected to each first processing unit. Each of M second antennas is separately connected to two different first processing units. A first processing unit connected to the first antenna is any one of two first processing units connected to the second antenna, and the first processing unit includes the power amplifier. The processing module is configured to send, by using one first processing unit, a first signal to the first antenna in a first time period. The processing module is configured to send, by using two first processing units, a second signal to the second antenna in a second time period. An amplitude of the second signal is greater than an amplitude of the first signal. The first antenna array is configured to radiate a millimeter wave signal based on the first signal. The second antenna array is configured to radiate a millimeter wave signal based on the second signal. Equivalently, the first antenna and the second antenna in this embodiment of this application multiplex one first processing unit, reducing a quantity of the first processing units in the millimeter wave module circuit and saving space on the terminal device.

In a possible case, the first processing unit 1310 includes a power amplifier 1311, a phase shifter 1312, a switch 1313, and a low noise amplifier 1314.

The power amplifier 1311 is configured to amplify a baseband signal whose phase is adjusted by the phase shifter 1312.

The switch 1313 may be a double-pole double throw (DPDT) switch, and usually includes four ports, namely, a port 1, a port 2, a port 3, and a port 4.

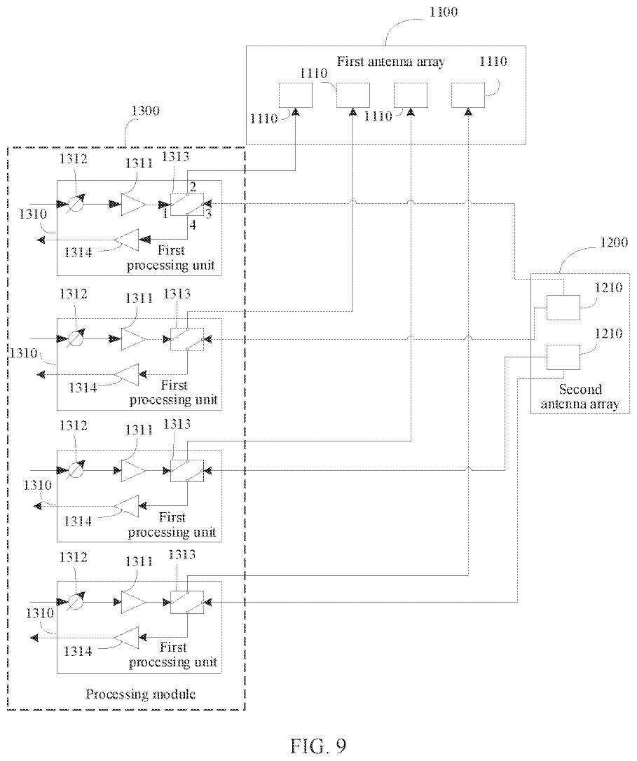

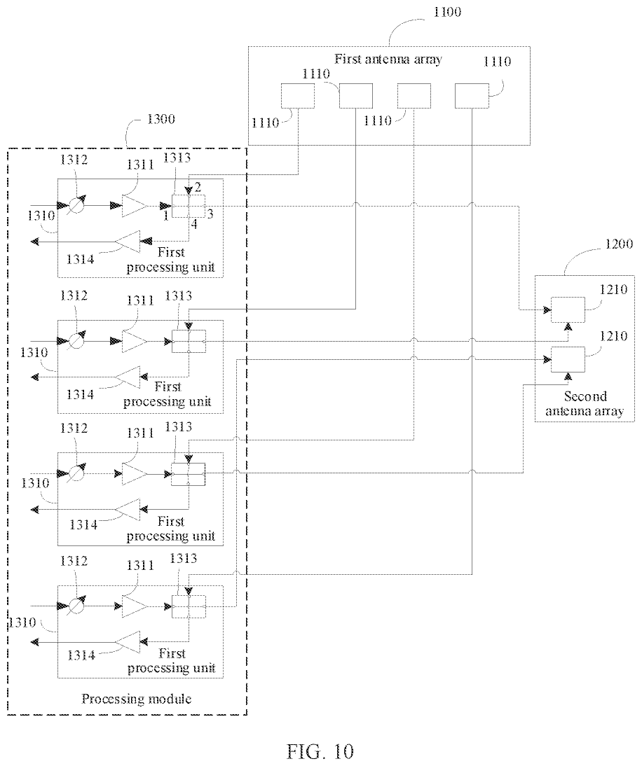

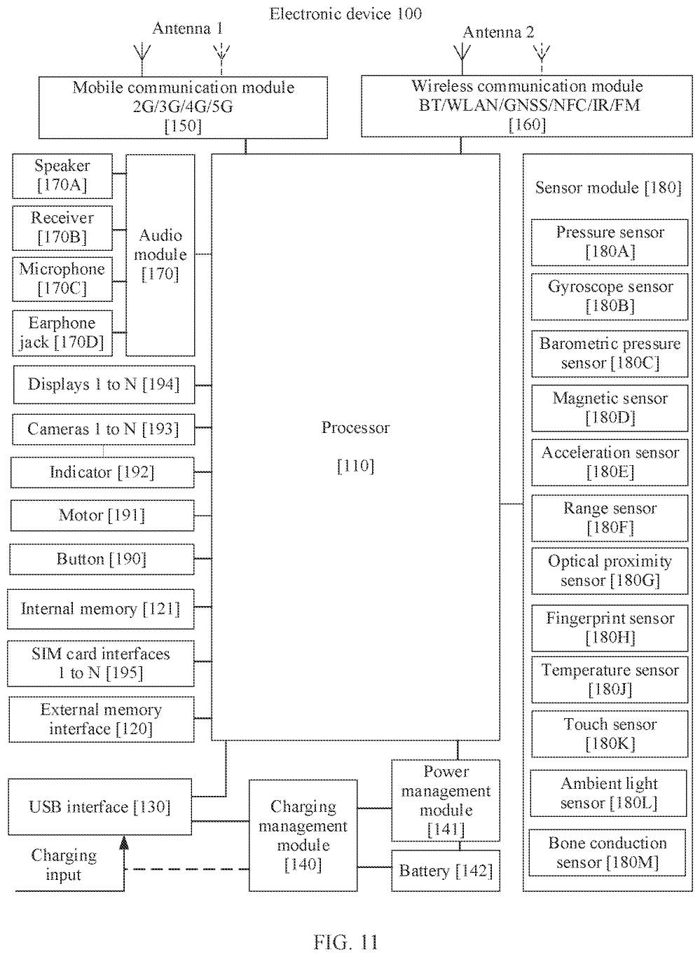

When the switch 1313 is in a first switch-on state, for example, as shown in FIG. 9, the port 1 and port 2 are turned off, and the port 3 and port 4 are turned off. In this case, a phase of the baseband signal is adjusted by the phase shifter 1312, and the baseband signal is amplified by the power amplifier 1311, and then emitted from the first antenna 1110 through the port 1 and the port 2 of the switch 1313. This enables the first antenna array 1100 to radiate the millimeter wave signal. Meanwhile, a signal received by the second antenna 1210 is input into the low noise amplifier 1314 through the port 3 and the port 4, and the received signal is processed by the low noise amplifier 1314 and input into a baseband module (not shown in the figure) for further processing.

When the switch 1313 is in a second switch-on state, for example, as shown in FIG. 10, the port 1 and port 3 are turned off, and the port 2 and port 4 are turned off. In this case, a phase of the baseband signal is adjusted by the phase shifter 1312, and the baseband signal is amplified by the power amplifier 1311 and then emitted from the second antenna 1210 through the port 1 and the port 3 of the switch 1313. This enables the second antenna array 1200 to radiate the millimeter wave signal. Meanwhile, a signal received by the first antenna 1110 is input into the low noise amplifier 1314 through the port 2 and the port 4, and the received signal is processed by the low noise amplifier 1314 and input into a baseband module (not shown in the figure) for further processing.

In this embodiment of this application, when the switch is in the first switch-on state, the processing module is configured to send the first signal to the first antenna and transmit the signal received by the second antenna to the low noise amplifier. When the switch is in the second switch-on state, the processing module is configured to send the second signal to the second antenna and transmit a signal received by the first antenna to the low noise amplifier. Therefore, when the first antenna and the second antenna multiplex one first processing unit, the second antenna array can receive a signal through different switch-on states of the switch when the first antenna array radiates the millimeter wave signal. When the second antenna array radiates the millimeter wave signal, the first antenna array receives a signal, preventing, when the first antenna array radiates the millimeter wave signal, that the second antenna array is to receive a signal through a same signal channel, or preventing, when the second antenna array radiates the millimeter wave signal, that the second antenna array is to receive a signal through a same signal channel, further preventing a signal conflict caused by receiving of a signal and radiation of the millimeter wave signal through the same signal channel.

A manner in which the first antenna 1110 and one first processing unit are connected and a manner in which the second antenna 1210 and two first processing units are connected are described in detail below.

It may be known from the foregoing description that one first processing unit connected to the first antenna 1110 may be any one of the first processing units connected to the second antenna 1210. It should be understood that the following examples may be included.

### Example 1

One first processing unit connected to each first antenna 1110 in the first antenna array 1100 is any one of two first processing units, that is, each first antenna 1110 and a second antenna 1210 multiplex one first processing unit.

In Example 1, when a quantity N of the first antennas 1110 is greater than 2*M, a quantity of a plurality of first processing units is N. When the quantity N of the first antennas 1110 is less than 2*M, the quantity of the plurality of first processing units is 2*M.

### Example 2

One first processing unit 1310 connected to one or more first antennas 1110 in the first antenna array 1100 is any one of two first processing units 1310 connected to a second antenna 1210, that is, some first antennas 1110 in the first antenna array 1100 and the second antenna 1210 multiplex one first processing units 1310.

In Example 2, when a quantity N of the first antennas 1110 is greater than 2*M, a quantity of a plurality of first processing units is greater than N. When the quantity N of the first antennas 1110 is less than 2*M, the quantity of the plurality of first processing units is greater than 2*M.

### Example 3

A second antenna 1210 is connected to two first processing units. One first processing unit connected to each first antenna 1110 in the first antenna array 1100 is any one of two first processing units connected to one second antenna 1210, that is, each first antenna 1110 and the second antenna 1210 multiplex one first processing unit.

In Example 3, when a quantity of the first antennas 1110 is N=2*M, in other words, the quantity of the first antennas 1110 is twice a quantity of the second antennas 1210, a quantity of a plurality of first processing units is N or 2*M.

For example, if the quantity of the first antennas 1110 is 4 and the quantity of the second antennas 1210 is 2, the quantity of the first processing units in the processing module is 4.

In this embodiment of this application, the quantity of the first antennas is twice the quantity of the second antennas, and a second antenna is connected to two first processing units. The quantity of the plurality of first processing units is N, and is equal to 2*M. That is, the millimeter wave module circuit in this embodiment of this application may be implemented by a least quantity of the first processing units, further saving the space on the terminal device.

### Example 4

A second antenna 1210 is connected to two first processing units 1310. One first processing unit 1310 connected to one or more first antennas 1110 in the first antenna array 1100 is any one of two first processing units 1310 connected to the second antenna 1210, that is, some first antennas 1110 and the second antenna 1210 multiplex one first processing unit.

In Example 4, when a quantity N of the first antennas 1110 is greater than 2*M, a quantity of a plurality of first processing units is N. When the quantity N of the first antennas 1110 is less than 2*M, the quantity of the plurality of first processing units is 2*M.

In an embodiment, an electronic device is provided. The electronic device may be a terminal device, and includes the millimeter wave module circuit in the embodiment shown in any one of the foregoing FIG. 2 to FIG. 10.

A type of the electronic device is not limited in this embodiment of this application. For example, the electronic device may be, but is not limited to a mobile phone, a tablet computer, a smart speaker, a smart big screen (also known as a smart TV), a wearable device, or the like.

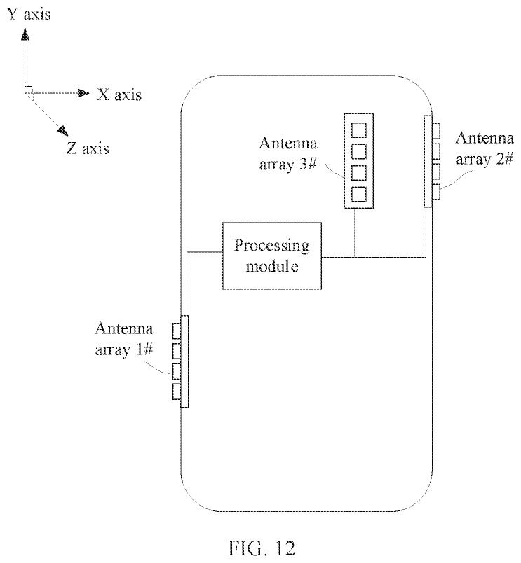

For example, FIG. 11 shows a schematic diagram of a structure of an electronic device 100. The electronic device 100 may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (SIM) card interface 195, and the like. The sensor module 180 may include a pressure sensor 180A, a gyroscope sensor 180B, a barometric pressure sensor 180C, a magnetic sensor 180D, an acceleration sensor 180E, a range sensor 180F, an optical proximity sensor 180G, a fingerprint sensor 180H, a temperature sensor 180J, a touch sensor 180K, an ambient optical sensor 180L, a bone conduction sensor 180M, and the like.

It may be understood that a structure shown in this embodiment of this application does not constitute a specific limitation on the electronic device 100. In some other embodiments of this application, the electronic device 100 may include more or fewer components than those shown in the figure, or combine some components, or split some components, or have a different component arrangement. The components shown in the figure may be implemented in hardware, software, or a combination of software and hardware.

The processor 110 may include one or more processing units. For example, the processor 110 may include an application processor (AP), a modem processor, a graphics processing unit (GPU), an image signal processor (ISP), a controller, a memory, a video codec, a digital signal processor (DSP), a baseband processor, a neural-network processing unit (NPU), and/or the like. Different processing units may be independent components, or may be integrated into one or more processors.

It may be understood that an interface connection relationship between modules illustrated in this embodiment of this application is merely an illustrative description, and does not constitute a limitation on the structure of the electronic device 100. In some other embodiments of this application, the electronic device 100 may alternatively use an interface connection manner different from that in the foregoing embodiment, or use a combination of a plurality of interface connection manners.

A wireless communication function of the electronic device 100 may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the electronic device 100 may be configured to cover one or more communication frequency bands. Different antennas may be further multiplexed to increase an antenna utilization rate. For example, the antenna 1 may be multiplexed as a diversity antenna in a wireless local area network. In some other embodiments, the antenna may be used in combination with a tuning switch.

The mobile communication module 150 may provide a solution applied to the electronic device 100 for wireless communication such as 2G/3G/4G/5G. The mobile communication module 150 may include at least one filter, a switch, a power amplifier, a low noise amplifier (LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert, through the antenna 1, the amplified signal into an electromagnetic wave for radiation. In some embodiments, at least some functional modules in the mobile communication module 150 may be disposed in the processor 110. In some embodiments, at least some functional modules of the mobile communication module 150 and at least some modules of the processor 110 may be disposed in a same component.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then the demodulator transmits the low-frequency baseband signal obtained by demodulation to the baseband processor for processing. The low-frequency baseband signal is processed by the baseband processor and then transmitted to the application processor. The application processor outputs a sound signal by an audio device (which is not limited to the speaker 170A, the receiver 170B, or the like), or displays an image or a video by the display 194. In some embodiments, the modem processor may be an independent component. In some other embodiments, the modem processor may be independent of the processor 110, and is disposed in a same component as the mobile communication module 150 or another functional module.

The wireless communication module 160 may provide a wireless communication solution that is applied to the electronic device 100, and that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like. The wireless communication module 160 may be one or more components integrating at least one communication processing module. The wireless communication module 160 receives an electromagnetic wave through the antenna 2, performs frequency modulation and filtering processing on the electromagnetic wave signal, and sends a processed signal to the processor 110. The wireless communication module 160 may further receive a to-be-sent signal from the processor 110, perform frequency modulation and amplification on the signal, and convert, through the antenna 2, an amplified signal with a frequency modulated into an electromagnetic wave for radiation.

In some embodiments, the antenna 1 and the mobile communication module 150 in the electronic device 100 are coupled, and the antenna 2 and the wireless communication module 160 are coupled, so that the electronic device 100 can communicate with a network and another device by using a wireless communication technology. The wireless communication technology may include a global system for mobile communication (GSM), a general packet radio service (GPRS), code division multiple access (CDMA), wideband code division multiple access (WCDMA), time-division code division multiple access (TD-SCDMA), long term evolution (LTE), a fifth generation (5G) communication system, BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

It should be noted that any electronic device mentioned in embodiments of this application may include more or less modules in the electronic device 100.

For example, when the terminal device is a mobile phone, one side of a body of the terminal device is a display and the other side is a backplate, and the display and the backplate are connected through a middle frame, and the display, the backplate, and the middle frame form an accommodating cavity. Two or more antenna arrays, such as a first antenna array and a second antenna array, are disposed in the accommodating cavity of the mobile phone.

The first antenna array is disposed in a plane in which the backplate is located, and the second antenna array is disposed in any plane in which the middle frame is located. Alternatively, the first antenna array and the second antenna array are respectively disposed in two different planes in which the middle frame is located.

Alternatively, if a third antenna array is further included, a plane in which the third antenna array is disposed is different from the plane in which the first antenna array is disposed and the plane in which the second antenna array is disposed.

For example, a millimeter wave module circuit includes an antenna array 1#, an antenna array 2#, and an antenna array 3 #, and positions of the antenna arrays be disposed freely. In addition, positions of the three (or more) antenna arrays may be set on a plane in which an X axis (including+/−X axis) of the terminal device is located, a plane in which a Y axis of the terminal device is located, or a plane in which a Z axis of the terminal device is located. The Z axis is perpendicular to a home screen, and linear array arrangement directions of the module 1#, the module 2#, and the module 3 # are parallel. Specifically, arrangement modes may be as follows.

For example, as shown in FIG. 12, the antenna array 1# is disposed on a middle frame of on a left side of a mobile phone, that is, in a plane in which the +X axis, is located and a millimeter wave beam emitted by the module 1# radiates to a left side of the mobile phone terminal. The antenna array 2# is disposed on a middle frame on a right side of the mobile phone, corresponding to a plane in which the —X axis is located, and emits a millimeter wave beam to a right side of the mobile phone terminal. The antenna array 3 # is disposed in the accommodating cavity, and is located in a plane in which a back of the mobile phone is located, that is, on a plane corresponding to the Z axis, and a millimeter wave beam is to be radiated to the back of the mobile phone terminal.

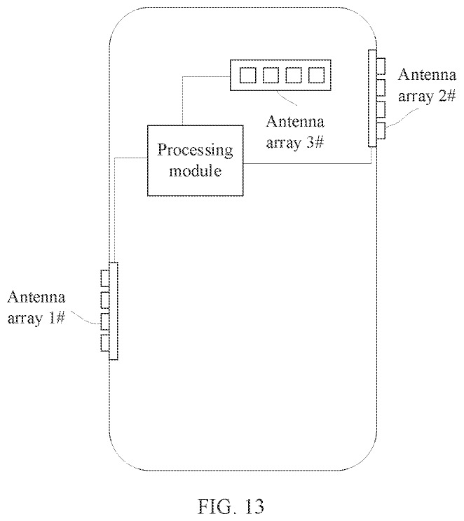

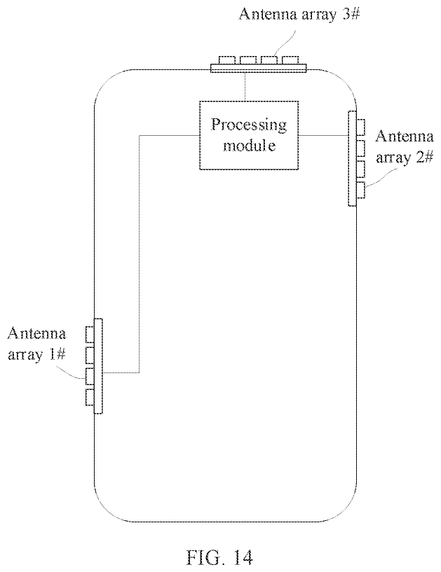

For another example, positions of the antenna array 1# and the antenna array 2# are kept unchanged, and only a position of the antenna array 3 # is changed. As shown in FIG. 13, the position of the antenna array 3 # is changed from a vertical direction to a horizontal direction. Alternatively, as shown in FIG. 14, the antenna array 3 # is disposed on the other side of a middle frame of the mobile phone, such as a side surface at the top of the middle frame of the mobile phone, and is corresponding to a plane of the Y axis.

It should be understood that in this embodiment, the antenna array 3 # may be alternatively disposed at another position of the mobile phone, and the position of the antenna array 3 # is not limited in this embodiment. In addition, the positions of the antenna array 1# and the antenna array 2# and positions of more antenna arrays may also be disposed freely. In this embodiment, specific positions of antenna arrays of a plurality of antenna arrays are not limited, as long as different antenna arrays are disposed on different planes in which the terminal device is located and the positions of antenna arrays are perpendicular to each other.

In the foregoing embodiments, the descriptions of various embodiments have respective focuses. For a part that is not described or recorded in detail in an embodiment, reference may be made to related descriptions in other embodiments. It should be understood that sequence numbers of the steps do not mean an execution sequence in the foregoing embodiments. The execution sequence of the processes should be determined based on functions and internal logic of the processes, and should not constitute any limitation on the implementation processes of embodiments of this application. In addition, in the descriptions of the specification and claims of this application, the terms “first”, “second”, “third”, and the like are merely intended for a purpose of differentiated description, but shall not be understood as an indication or an implication of relative importance. Reference to “an embodiment”, “some embodiments”, or the like described in the specification of this application means that specific features, structures, or characteristics described with reference to the embodiment are included in one or more embodiments of this application. Therefore, the phrases “in an embodiment,” “in some embodiments,” “in some other embodiments,” “in another embodiment,” and the like appearing in various places in this specification do not necessarily mean same embodiments, but mean “one or more but not all of embodiments” unless specifically emphasized otherwise.

Finally, it should be noted that the foregoing descriptions are merely specific implementations of this application, but the protection scope of this application is not limited thereto. Any variation or replacement within the technical scope disclosed in this application shall fall within the protection scope of this application. Therefore, the protection scope of this application shall be subject to the protection scope of the claims.

1. A millimeter wave antenna circuit, comprising:
a first antenna array;
a second antenna array; and
a processor;
wherein the first antenna array comprises N first antennas, and the second antenna array comprises M second antennas, wherein N is greater than M;
wherein the processor comprises a plurality of first processing units, each of the N first antennas is connected to a first processing unit in the plurality of first processing units in a one-to-one correspondence, each of the M second antennas is in a differential connection to two different first processing units in the plurality of first processing units, and each first processing unit in the plurality of first processing units comprises a power amplifier;
wherein the processor is configured to send a first signal to the first antenna array by using one first processing unit connected to one of the N first antennas;
wherein the processor is configured to send, through differential feeding, a second signal to the second antenna array by using two different first processing units connected to one of the M second antennas;
wherein the first antenna array is configured to radiate a first millimeter wave signal based on the first signal; and
wherein the second antenna array is configured to radiate a second millimeter wave signal based on the second signal.

2. The millimeter wave antenna circuit according to claim 1,
wherein each first processing unit in the plurality of first processing units further comprises a phase shifter, and the phase shifter is configured to adjust a phase of an input signal received by the first processing unit;
wherein the processor is configured to obtain a third signal by using the phase shifter in a first target processing unit;
wherein the processor is configured to obtain a fourth signal by using the phase shifter in a second target processing unit, and a phase is opposite between the third signal and the fourth signal;
wherein the second signal is a differential signal obtained by combining the third signal and the fourth signal; and
wherein the first target processing unit is one of the two different first processing units, and the second target processing unit is the other of the two different first processing units.

3. The millimeter wave antenna circuit according to claim 1, wherein a first processing unit connected to the first antenna array is one of the two different first processing units.

4. The millimeter wave antenna circuit according to claim 3, wherein the processor is configured to send the first signal to the first antenna array in a first time period and send the second signal to the second antenna array in a second time period.

5. The millimeter wave antenna circuit according to claim 4,
wherein each first processing unit in the plurality of first processing units further comprises a switch and a low noise amplifier;
wherein when the switch is in a first switch-on state, the processor is configured to send the first signal to the first antenna array and transmit a signal received by the second antenna array to the low noise amplifier; and
wherein when the switch is in a second switch-on state, the processor is configured to send the second signal to the second antenna array and transmit a signal received by the first antenna array to the low noise amplifier.

6. The millimeter wave antenna circuit according to claim 5,
wherein the switch is a double-pole double throw switch, and the power amplifier is separately connected to a phase shifter and the double-pole double throw switch;
wherein when the switch is in the first switch-on state, the power amplifier is connected to the first antenna array through the double-pole double throw switch, and the low noise amplifier is connected to the second antenna array through the switch; and
wherein when the switch is in the second switch-on state, the power amplifier is connected to the second antenna array through the double-pole double throw switch, and the low noise amplifier is connected to the first antenna array through the switch.

7. The millimeter wave antenna circuit according to claim 6, wherein a quantity of the plurality of first processing units is greater than or equal to N and greater than or equal to 2*M.

8. (canceled)

9. A terminal device, comprising:
a body, wherein one side of the body comprises a display, and the other side of the body comprises a backplate, and the display and the backplate are connected through a middle frame; and
wherein the display, the backplate, and the middle frame form an accommodating cavity, and the millimeter wave antenna circuit according to claim 1 is disposed in the accommodating cavity.

10. The terminal device according to claim 9,
wherein the first antenna array is disposed in a plane in which the backplate is located, and the second antenna array is disposed in any plane in which the middle frame is located; or
wherein the first antenna array and the second antenna array are respectively disposed in two different planes in which the middle frame is located.

11. A millimeter wave antenna circuit, comprising:
a first antenna array;
a second antenna array; and
a processor;
wherein:
the first antenna array comprises N first antennas, and the second antenna array comprises M second antennas, wherein N is greater than M;
the processor comprises a plurality of first processing units, each of the N first antennas is connected to a first processing unit in the plurality of first processing units in a one-to-one correspondence, each of the M second antennas is in a differential connection to two different first processing units in the plurality of first processing units, and each first processing unit in the plurality of first processing units comprises a power amplifier and a phase shifter, and the phase shifter is configured to adjust a phase of an input signal received by the first processing unit;
the processor is configured to send a first signal to the first antenna array by using one first processing unit connected to one of the N first antennas;
the processor is configured to send, through differential feeding, a second signal to the second antenna array by using two different first processing units connected to one of the M second antennas;
wherein the processor sending, through the differential feeding, the second signal to the second antenna array by using two different first processing units connected to one of the M second antennas comprises:
the processor obtaining a third signal by using the phase shifter in a first target processing unit;
the processor obtaining a fourth signal by using the phase shifter in a second target processing unit, wherein a phase is opposite between the third signal and the fourth signal, and wherein the second signal is a differential signal obtained by combining the third signal and the fourth signal;
wherein the first target processing unit is one of the two different first processing units, and the second target processing unit is the other of the two different first processing units;
wherein the first antenna array is configured to radiate a first millimeter wave signal based on the first signal; and
wherein the second antenna array is configured to radiate a second millimeter wave signal based on the second signal.

12. The millimeter wave antenna circuit according to claim 11, wherein a first processing unit connected to the first antenna array is one of the two different first processing units.

13. The millimeter wave antenna circuit according to claim 12, wherein the processor is configured to send the first signal to the first antenna array in a first time period and send the second signal to the second antenna array in a second time period.

14. The millimeter wave antenna circuit according to claim 13,
wherein each first processing unit in the plurality of first processing units further comprises a switch and a low noise amplifier;
wherein when the switch is in a first switch-on state, the processor is configured to send the first signal to the first antenna array and transmit a signal received by the second antenna array to the low noise amplifier; and
wherein when the switch is in a second switch-on state, the processor is configured to send the second signal to the second antenna array and transmit a signal received by the first antenna array to the low noise amplifier.

15. The millimeter wave antenna circuit according to claim 14,
wherein the switch is a double-pole double throw switch, and the power amplifier is separately connected to a phase shifter and the double-pole double throw switch;
wherein when the switch is in the first switch-on state, the power amplifier is connected to the first antenna array through the double-pole double throw switch, and the low noise amplifier is connected to the second antenna array through the switch; and
wherein when the switch is in the second switch-on state, the power amplifier is connected to the second antenna array through the double-pole double throw switch, and the low noise amplifier is connected to the first antenna array through the switch.

16. The millimeter wave antenna circuit according to claim 15, wherein a quantity of the plurality of first processing units is greater than or equal to N and greater than or equal to 2*M.

17. (canceled)
